(19) United States
(12) Patent Application Publication
(10) Pub. No.: US 2022/0168163 A1
(43) Pub. Date: Jun. 2, 2022

(54) Bodily Transfer and Lifting Device

(71) Applicant: Joyce White, Gretna, VA (US)

(72) Inventor: Joyce White, Gretna, VA (US)

(21) Appl. No.: 17/321,595

(22) Filed: May 17, 2021

Related U.S. Application Data
(60) Provisional application No. 63/120,284, filed on Dec. 2, 2020.

(51) Int. Cl. A61G 7/10

(52) U.S. Cl. CPC A61G 7/1032; A61G 7/1051; A61G 7/1073

(57) ABSTRACT

This present invention relates to a patient transfer and lifting device that can be easily used by caregivers or other users to securely lift and transfer an individual with limited or no mobility from one place to another. The transfer device features a relatively soft pad structure comprising a plurality of continuous openings through which a belt is threaded. The soft pad and belt structure provide a support sling while lifting individuals, and thereby reduces the likelihood of injury to both the transferor and the transferee during the transfer movement. The device also provides the transferee with something to hold onto while being transferred, thereby alleviating the fear of falling or being dropped.

### CROSS-REFERENCE TO RELATED APPLICATION

The present application claims priority to, and the benefit of, U.S. Provisional Application No. 63/120,284, that was filed on Dec. 2, 2020 and is incorporated herein by reference in its entirety.

### FIELD OF THE INVENTION

The present invention relates generally to the field of bodily transfer and lifting devices. More specifically, the present invention relates to an improved transfer wrap that can be used by one or two individuals to securely transfer an individual or patient with limited to no mobility, from one place to another. The transfer wrap comprises a pad body with a belt threaded through openings at the corners of the pad, wherein the pad can be used to safely and securely transfer an individual with limited mobility. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, in hospitals, healthcare centers, nursing homes and other similar facilities, it is oftentimes required to transfer patients, injured people or elderly individuals, etc. who are not capable of moving themselves from one place to another. In one exemplary situation, a person may be transferred or moved from one seated position to another seated position. This type of transfer may occur when moving a patient from a wheel chair to another fixed chair or couch (or vice versa). One or more caregivers must provide assistance to the individual, who cannot move without assistance in order to physically transfer the individual from one place to another.

Unfortunately, lifting and moving patients is ergonomically difficult for caregivers. For example, while manually lifting a patient, there is always a risk of back injuries to the caregiver. Additionally, in the event the patient or individual is not handled properly, there is a risk that the patient may be dropped or otherwise fall to the ground, thereby causing additional injury to the patient and potential liability to the caregiver and/or the facility. Injuries to patients and/or caregivers can cause any number of detrimental consequences affecting the long-term health and financial well-being of all those involved.

Hospitals, healthcare centers, nursing homes and other similar facilities may be equipped with mechanical lifts to quickly transfer patients from one place to another. However, if such lifts are under maintenance, are not working due to technical problems or are not conveniently available, the caregivers may have to transfer the patients manually. While moving a patient without an available lift, caregivers oftentimes struggle to safely move the patient from one place to another. Additionally, many patients, while being manually transferred, do not feel secure and may panic during the moving process, especially because there is usually nothing to hold onto. Without supplemental support, caregivers have difficulty lifting the patient, which can put both the caregivers and the patient at risk for falls and injuries.

Various devices are available in the state of the art to assist caregivers in lifting and moving patients, elderly people, etc. from one place to another. For example, lifting devices such as gait belts, waist belts and the like are available to lift patients or elderly individuals. A gait belt is a padded belt that fits around the patient's lower rib cage area to lift the patient. However, conventional gait belts can be problematic for both the patient and the caregivers. For example, gait belts are usually uncomfortable for patients and have a tendency to slide up or down during the transfer, thereby potentially causing the patient to fall and become injured. Additionally, a gait belt is an elongated belt with no substantial support structure for lifting patients, so it may be difficult for the caregivers to use. Additional effort may be required in lifting and moving patients from one place to another when using the gait belt. Furthermore, the material typically used for traditional gait belts is relatively rough, and may cause bruising, skin rashes, skin tears and more, which tend to create discomfort and possible infection for the patient, elderly individual, etc.

Therefore, there exists a long felt need in the art for a patient lifting means or device that enables caregivers to lift and move patients from one place to another. Additionally, there is a long felt need in the art for a patient lifting means that ensures patients, elderly people or the like, are safely and securely transferred from one place to another without causing injury to the patient and/or the caregiver. Moreover, there is a long felt need in the art for a patient lifting device that provides substantial support to the patient being transferred, thereby reducing the patient's anxiety about being moved. Further, there is a long felt need in the art for a patient transfer device that is both relatively lightweight and portable, and that does not result in skin rashes, skin tears or bruising to the patient due to the material of the lifting device. Finally, there is a long felt need in the art for a patient lifting device that is relatively inexpensive to manufacture and that is both safe and easy to use.

The subject matter disclosed and claimed herein, in one embodiment thereof, comprises a patient transfer and lifting device for securely lifting and transferring a patient from one location to another by a caregiver. The device comprises a generally rectangular pad having one continuous opening at each corner of the pad, and a belt continuously threaded through the openings with two open ends of the belt accessible to the patient or caregiver. The belt may further comprise a fastening means to securely fasten the two open ends for wrapping around the caregiver for additional support while lifting the patient seated on the pad. During transfer, the patient can be further supported by holding the pad about the edges.

In this manner, the novel bodily transfer and lifting device of the present invention accomplishes all of the forgoing objectives, and provides a relatively safe, easy, convenient and efficient solution to lifting and transferring patients, invalids, injured and elderly individuals and or other individuals who are not otherwise capable of moving themselves from one place to another, and without causing any injuries to the patient and/or the caregivers. The novel bodily transfer and lifting device of the present invention is also user friendly, inasmuch as it does not require a great deal of user effort or labor to lift a patient, elderly individual or the like. The device provides substantial support to properly lift an individual, thereby preventing or at least reducing the likelihood of injuries to the patient and/or the caregiver. Finally, the relatively soft and flexible material of the device provides a more comfortable and enhanced experience for both the caregiver and the patient or individual being moved.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a novel bodily transfer and lifting device for use by a caregiver or other individual to securely lift and/or transfer a patient or other individual from one location to another. It is to be appreciated that the device provides a support mechanism to assist a caregiver in moving, for example, a patient from a first seated position to a second seated position, or from a seated position to a standing position and then to another seated position, or any other combination of movements. The device preferably comprises a generally rectangular pad having one continuous opening therein at each of the four corners of the pad, and a belt continuously threaded through said openings. The belt comprises two open ends accessible to a patient or a caregiver, wherein the belt has a fastening means to securely fasten the two open ends for wrapping around the caregiver for extra support while lifting the patient who is seated on the pad of the device. During use, the patient is lifted when the caregiver pulls backward in a direction away from the patient. Tension in the belt provides a securement around both the caregiver and patient, and further support can result from the caregiver and/or patient holding the pad at its edges.

In a further embodiment of the present invention, a medical transfer device is disclosed that comprises a seating pad and a strap system. The seating pad has a plurality of continuous openings that allow a belt to be pulled through the openings. The belt has two open ends that are wrapped around a caregiver and connected together, thereby creating a closed loop system or structure between the pad and belt, similar to a sling, to securely lift and transfer a patient from one seated location to another seated location. The seating pad may be constructed of a layered and relatively soft, flexible material. The layered pad may be constructed to any size, but can include a length of approximately 36 inches and a width of approximately 24 inches to accommodate most patients and applications. The belt preferably has a length of approximately 138 inches and a width of approximately 2-3 inches. The openings in the pad can be circumscribed by reinforced stitching, and preferably include a diameter of approximately 2-3 inches to accommodate the width of the belt.

In yet a further embodiment of the present invention, a portable sling device to transfer patients that need assistance moving from one location to another is disclosed. The sling device comprises an ultra-soft and ergonomic rectangular cushioned pad having a variable density along its seating area. The pad is comprised of a top layer, a bottom layer and a plurality of continuous openings extending from the top layer to the bottom layer, wherein the continuous openings may be positioned at the opposing corners of the cushioned pad. The device further comprises a relatively thick and strong pull belt that is threaded through the continuous openings and may be wrapped about a caregiver to form a closed loop system when the open ends of the belt are attached to one another. The means of attachment between the two open ends of the belt may include, but are not limited to, a hook and loop fastener, a buckle-socket connector, a snap, or any other similar heavy duty connection means.

The present invention discloses a transfer and lifting sling device that allows for the easy, safe, and convenient transfer of a patient who needs assistance in moving from one location to another. The device ensures that one or two caregivers are able to easily move the patient without injury to the caregivers and/or the patient. The device can be used by hospitals, nursing homes, physical therapists, homeowners or the like to provide support to a patient, an elderly individual or any other person in need of assistance to transfer between two seated locations.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in that similar reference characters refer to similar parts throughout the different views, and in that:

FIG. 1 illustrates a perspective view of one potential embodiment of the bodily transfer and lifting device of the present invention in accordance with the disclosed architecture;

FIG. 2 illustrates a perspective view of one potential embodiment of the bodily transfer and lifting device of the present invention positioned in a wheelchair in accordance with the disclosed architecture;

FIG. 3 illustrates a perspective view of one potential embodiment of the bodily transfer and lifting device of the present invention positioned in a wheelchair in accordance with the disclosed architecture, wherein a patient is sitting on the device and is ready to be transferred to another location;

FIG. 4 illustrates a perspective view of one potential embodiment of the bodily transfer and lifting device of the present invention positioned in a wheelchair in accordance with the disclosed architecture, wherein a patient is sitting on the device and a caregiver is initiating the transfer movement of the patient to another location;

FIG. 5 illustrates a perspective view of one potential embodiment of the bodily transfer and lifting device of the present invention in accordance with the disclosed architecture, wherein the caregiver is in the process of using the device to transfer the patient from the wheelchair to a couch;

FIG. 6 illustrates a perspective view of one potential embodiment of the bodily transfer and lifting device of the present invention in accordance with the disclosed architecture, wherein the caregiver is in the process of using the device to transfer the patient from the wheelchair to a couch and has successfully turned the patient with the device; and

FIG. 7 illustrates a flow chart of one potential embodiment of the method of using the bodily transfer and lifting device of the present invention in accordance with the disclosed architecture to move a patient from one location to another.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a bodily transfer and lifting device that enables a caregiver to lift and move a patient or other injured individual from one place to another. Additionally, there is a long felt need in the art for a bodily transfer and lifting device that ensures that the patient, elderly individual or the like is safely and securely transferred from one place to another without causing any injuries to the patient and/or the caregiver. Moreover, there is a long felt need in the art for a bodily transfer and lifting device that provides substantial support to the patient being transferred, thereby reducing the patient's anxiety about being moved and/or falling. Further, there is a long felt need in the art for a bodily transfer and lifting device that is both relatively lightweight and portable, and that does not result in skin rashes, skin tears or bruising to the patient from the material of the lifting device. Finally, there is a long felt need in the art for a bodily transfer and lifting device that is relatively inexpensive to manufacture and that is both safe and easy to use.

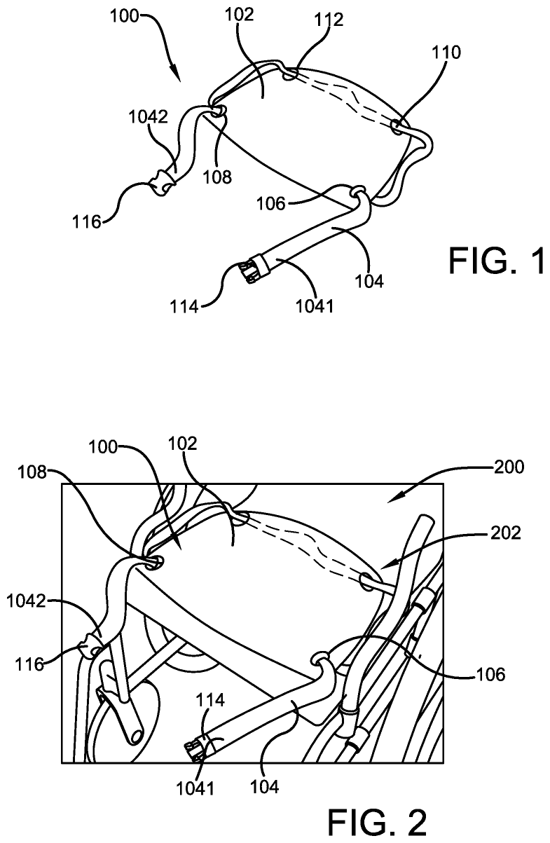

Referring initially to the drawings, FIG. 1 illustrates a perspective view of one potential embodiment of the bodily transfer and lifting device 100 of the present invention in accordance with the disclosed architecture. The transfer and lifting device 100 comprises a relatively flat and flexible pad 102 on which a patient can sit comfortably. The flexible pad 102 can be made up of foam or other compressible materials to provide pressure redistribution features. Additionally, the top surface of the flexible pad 102 can be made up of urethane-coated nylon that is low-shear, vapor permeable and waterproof. In a preferred embodiment of the present invention, the shape of the flexible pad 102 is generally rectangular, but the invention is not so limited and the shape of the pad 102 may be any geometric or non-geometric shape that satisfies user need and/or preference.

The flexible pad 102 can have a hole or continuous opening positioned at each of its four corners. Each continuous opening 106, 108, 110, 112 extends from the top surface of the pad 102 to the bottom surface and can be used for threading a belt 104 therethrough, as best shown in FIG. 1. The belt 104 is preferably 2-3 inches in width, and the diameter of each of the openings 106, 108, 110, 112 should be made large enough to easily accommodate the belt 104 being threaded therethrough. The belt 104 is a length of durable and relatively strong material, and comprises a first end 1041 and a second end 1042. Each of the ends 1041, 1042 of the belt 104 can be easily accessed by the user while using the patient transfer sling device 100 of the present invention to move or reposition a patient from one location to another. In one exemplary embodiment, the first free end 1041 of the belt may include a buckle member 114, and the second free end 1042 of the belt may have a corresponding socket member 116 to connect the free ends 1041, 1042 together as needed. When the two free ends 1041, 1042 of the belt 104 are connected, the belt 104 forms a closed or continuous loop with the pad 102 to provide additional support for both the patient and the caregiver during the transfer movement. The belt 104 can be tightened or loosened using loops (not shown) as necessary to accommodate different sizes of caregivers and patients.

As best shown in FIG. 1, the belt 104 can be passed through each of the openings 106, 108, 110 and 112 present at each corner of the flexible pad 102. To replace or remove the belt 104 from the flexible pad 102, for example if the same becomes soiled or otherwise damaged, the buckle member 114 and the socket member 116 can be easily removed and can be replaced with a new belt 103. The flexible pad 102 can also be made from a relatively soft and flexible reinforced material, that is cut and folded together in a multi-layer arrangement. In one illustrative embodiment, the pad 102 is approximately 36 inches long and approximately 24 inches wide to accommodate most patients and/or applications. The belt 104 can be, for example, approximately 138 inches in length, as measured between the first and second free ends 1041, 1042. Nonetheless, it is to be appreciated that the length of the belt 104 should be in excess of a circumference defined by two adults standing adjacent to one another. Accordingly, the length of the belt 104 should range from approximately 72 inches to approximately 156 inches. In the present embodiment, each hole or opening 106, 108, 110 and 112 should have a diameter of, for example, approximately 2-3 inches, though the diameter may vary provided that it can accommodate the width of the belt 104.

As noted above, the belt 104 is used by a caregiver or other person to wrap around him or herself while holding the flexible pad 102. An additional caregiver or lifter can provide supplemental leverage by holding the flexible pad 102 to securely support the patient or other individual being moved from one place to another, wherein the patient is safely sitting on the flexible pad 102 while in the seated orientation. Upon rising from a seated orientation, the tension on the belt 104 and the pad 102 contribute to retaining the pad 102 in a substantially fixed position under the posterior of the patient or other individual being moved. The fixed position prohibits slipping of the pad 102, and helps to retain the pad 102 in a proper position beneath and behind the patient during the transfer movement from, for example, a first seat to a second seat. Additionally, the belt 104 can be wrapped around the caregiver's shoulders or torso to provide additional support to both the caregiver and the patient while completing the maneuver.

FIG. 2 illustrates a perspective view of one potential embodiment of the bodily transfer and lifting device 100 of the present invention positioned in a wheelchair 200 in accordance with the disclosed architecture. The transfer and lifting device 100 can be made commercially available as an accessory to a wheelchair 200, or separately as a standalone unit for individuals and caregivers to use at home or in a medical facility. The flexible pad 102 is designed to be placed on the seat 202 of the wheelchair 200, and the free ends 1041, 1042 of the belt or strap 104 hang in front of the seat 202 for easy access by a lifter or caregiver. The free ends 1041, 1042 can be pulled from the openings 106, 108 respectively to tighten the belt 104 passing through the four openings 106, 108, 110 and 112 present on the four corners of the flexible pad 102.

As noted above, the free or open ends 1041, 1042 of the belt 104 may have an attachment mechanism that utilizes hook and loop fasteners, snap locks, buckle and socket connectors, auto seat belt buckles, airplane seat belt buckles or the like for making a closed loop connection around the caregiver or lifter. Alternatively, a tight knot can be made using both of the open ends 1041, 1042 to form the continuous loop in the belt 104. The length of the belt 104 between consecutive openings remains secure, and can be tightened in accordance with the user requirements. The flexible pad 102 should be constructed to be sufficiently strong to accommodate the transfer of a patient weighing up to 400 lbs. The openings in the pad 102 can be circumscribed by zigzag or reinforced cross stitching for secure engagement of the belt 104 to the pad 102 when the belt 104 is threaded through the openings 106, 108, 110, 112. The reinforced cross stitching improves the quality of construction and integrity of the flexible pad 102. The flexible pad 102 is machine washable and can come in various ergonomic configurations to help aid in the comfort of both the caregiver and the patient during transfer movements.

The pad 102 and the belt 104 can also be constructed of waterproof material to provide protection from liquids and bodily fluids, and may further comprise an anti-microbial coating 118, such as Microban®, to prevent the transmission of bacteria, germs, infectious diseases and other harmful microbes that may come into contact with the pad 102 and/or the strap 104, as the same are being handled and used by multiple caregivers and/or patients.

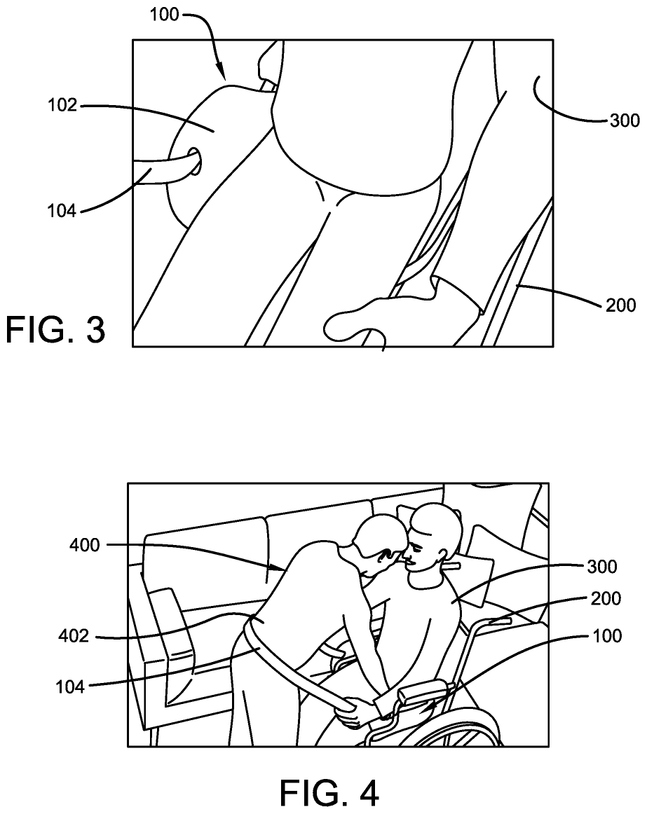

FIG. 3 illustrates a perspective view of one potential embodiment of the bodily transfer and lifting device 100 of the present invention positioned in a wheelchair 200 in accordance with the disclosed architecture, wherein a patient 300 is sitting on the device 100 and is ready to be transferred to another location. More specifically, the device 100 can be placed on the wheelchair 200 in preparation for use, and the flexible pad 102 of the device 100 is ergonomic, stable and relatively soft for the patient 300 to comfortably sit thereon. The free ends 1041, 1042 of the belt 104 are made to be easily accessible to the caregiver for wrapping and securing around oneself prior to transferring the patient 300 from one seated position to another seated position. A patient 300 can sit, for example, on a wheelchair 200 with the pad 102 between the person's posterior and the seat 202 of the wheelchair 200. The pad's flexible and relatively thin construction ensures that the person 300 sitting on the pad 102 can barely detect its presence. When not in use, the free ends of the belt 104 can be tied to the handles of the wheelchair 200 so that the patient transfer sling device 100 does not fall from the wheelchair 200 or otherwise become displaced.

FIG. 4 illustrates a perspective view of one potential embodiment of the bodily transfer and lifting device 100 of the present invention positioned in a wheelchair 200 in accordance with the disclosed architecture, wherein the patient 300 is sitting on the device 100 and a caregiver 400 is initiating the transfer movement of the patient 300 to another location. More specifically, FIG. 4 illustrates the initial arrangement of the device 100 just prior to lifting a patient 300 from the seat 202 of the wheelchair 200 with the belt 104 wrapped around the caregiver 400. As shown, the caregiver 400 wraps and secures the belt 104 around his waist 402 while holding onto the flexible pad 102 with both hands. In one preferred embodiment, the flexible pad 102 is held along its length to give further stability and support to the patient 300 during the transfer.

The belt 104 is wrapped and secured around the shoulders or waist 402 of the caregiver 400 by attaching the free ends of the belt 104 together to form a continuous loop. As stated above, any conventional fastening means can be used to easily fasten the free ends 1041, 1042 of the belt 104 to make a closed loop with the flexible pad 102. It is to be appreciated that the patient 300 does not need to hold the caregiver 400 for support, but may choose to do so. The patient 300 can also grasp the belt 104 at any convenient location along its length for stability as the transfer movement occurs from a first seated position to a second seated position. If required, an additional caregiver (not shown) can also hold the flexible pad 102 to gain more stability while moving the patient 300.

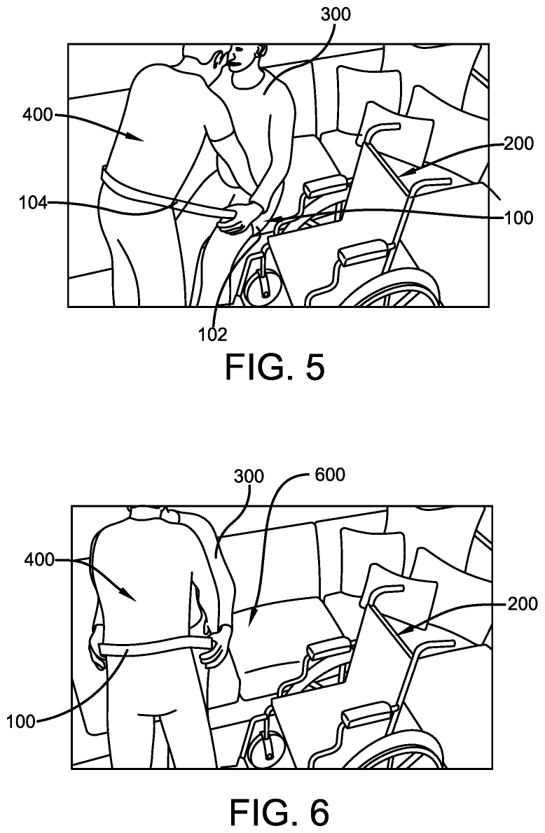

FIG. 5 illustrates a perspective view of one potential embodiment of the bodily transfer and lifting device 100 of the present invention in accordance with the disclosed architecture, wherein the caregiver 400 is in the process of making the transfer. More specifically, the caregiver 400, while the belt 104 is wrapped and connected around his or her body, securely lifts the patient 300 by holding respectively opposing edges of the flexible pad 102 with each hand. During the lift, the patient 300 holds the belt 104 for stability and control. During transfer, tension is created on the belt 104 and the pad 102, thereby preventing slippage of the device 100 about the caregiver 400 and/or patient 300. As best shown in FIG. 5, the patient 300 can be transferred from a wheelchair 200 (i.e. first seated position) to a second different seated position, such as a couch 600 in a waiting area or to a hospital bed. The patient transfer device 100 allows the caregiver 400 to easily move the patient 300 in a manner that is both safe and secure, and the device 100 is especially useful for stroke victims and other patients that need assistance in moving from one location to another location.

FIG. 6 illustrates a perspective view of one potential embodiment of the bodily transfer and lifting device 100 of the present invention in accordance with the disclosed architecture, wherein the caregiver 400 is in the process of using the device 100 to transfer the patient from a wheelchair 200 to a couch 600 and has successfully turned the patient with the device 100. More specifically, the patient 300 is transferred to a desired second position, such as a sofa 600, using the patient transfer sling device 100. Once transferred, the belt 104 is then unwrapped from the caregiver 400 and may be conveniently stored until needed again. Alternatively, the device 100 can be kept underneath the patient 300 for a subsequent transfer (e.g., back to the wheelchair 200).

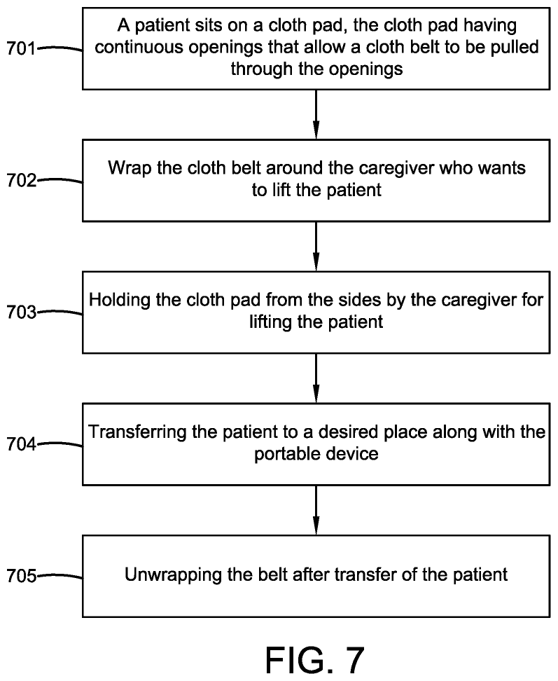

FIG. 7 illustrates a flow chart of one potential embodiment of the method 700 of using the bodily transfer and lifting device 100 of the present invention in accordance with the disclosed architecture to move a patient 300 from one location to another. Initially, a patient 300 sits on the flexible pad 102 of the patient transfer sling device 100 at Block 701. Alternatively, the flexible pad 102 can be slid underneath the patient 300. The flexible pad 102 includes openings (one at each corner) 106, 108, 110, 112 that allow the flexible belt 104 to be pulled through the openings. Next, the flexible belt 104 is wrapped around a caregiver 400 and secured thereto. The caregiver can then utilize the device 100 to both lift and transfer the patient 300 to a secondary location at Block 702. The patient 300 is supported by the caregiver 400 by holding the flexible pad 102 from the sides with support from the wrapped belt 104 at Block 703. The patient 300 is lifted and transferred to another location while the patient 300 remains supported and seated on the flexible pad 102 at Block 704. After successful transfer of the patient 300, the belt 104 can be unwrapped by the caregiver 400, and the pad 102 left in place underneath the patient 300, ready to be used for a subsequent transfer of the patient 300 at Block 705. It should be appreciated that an additional caregiver can help in lifting the patient 300 by holding the flexible pad 102 during transfer (not shown).

For use with adult and young patients, the flexible pad 102 can be, for example, in the range of 12 to 42 inches in length and 12 to 36 inches in width. The length of the belt 104 can be, for example, in the range of 72 inches to 156 inches. On the top surface of the flexible pad 102, any logo, design, print, trademark, hospital name or the like can be printed or embossed thereon.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “patient transfer sling device”, “patient transfer device”, “patient lifting device”, “medical transfer sling” and “transfer sling” are interchangeable and refer to the patient transfer and lifting device 100 of the present invention.

Notwithstanding the forgoing, the patient transfer and lifting device 100 of the present invention and its various components can be of any suitable size and configuration as is known in the art without affecting the overall concept of the invention, provided that it accomplishes the above stated objectives. One of ordinary skill in the art will appreciate that the size, configuration and material of the patient transfer and lifting device 100 and its components as shown in the FIGS. are for illustrative purposes only, and that many other sizes and shapes of the patient transfer and lifting device 100 are well within the scope of the present disclosure. Although the dimensions of the patient transfer and lifting device 100 are important design parameters for user convenience, the patient transfer and lifting device 100 and its components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A patient transfer and lifting device configured to enable a first individual to reposition a second individual from a first position to a second position, the patient transfer and lifting device comprising:
a pad portion, wherein said pad comprises a flexible material having a plurality of continuous openings therein;
a belt threaded through said plurality of continuous openings in said pad portion, wherein said belt comprises a first end and a second end; and
an attachment mechanism for removably attaching the first end to the second end to form a continuous loop with the pad portion.

2. The patient transfer and lifting device of claim 1, wherein said pad portion further comprises a plurality of layers.

3. The patient transfer and lifting device of claim 2, wherein said belt further comprises an adjustment mechanism for selective lengthening or shortening of said belt.

4. The patient transfer and lifting device of claim 3, wherein said pad portion is waterproof.

5. The patient transfer and lifting device of claim 4, wherein said belt comprises a length ranging from approximately 72 inches to approximately 156 inches.

6. The patient transfer and lifting device of claim 5, wherein said first position is a seated position and said second position is another seated position.

7. The patient transfer and lifting device of claim 6, wherein said attachment mechanism is selected from a group consisting of a snap lock, a hook and loop fastener, an auto seat belt buckle, a buckle socket connector and an airplane seat belt buckle.

8. A patient transfer and lifting device configured to enable a first individual to reposition a second individual from a first position to a second position, the patient transfer and lifting device comprising:
a pad portion comprised of a flexible material and having a first opening, a second opening, a third opening and a fourth opening therein;
a belt threaded through each of said first, second, third and fourth openings, wherein said belt comprises a first end and a second end;
an attachment mechanism; and
an adjustment mechanism positioned along said belt.

9. The patient transfer and lifting device of claim 8 further comprising an anti-microbial coating.

10. The patient transfer and lifting device of claim 9, wherein said belt has a length ranging from approximately 72 inches to approximately 156 inches.

11. The patient transfer and lifting device of claim 10, wherein said first position is a seated position and said second position is another seated position.

12. The patient transfer and lifting device of claim 11, wherein said pad portion is washable after selective removal of said belt from said pad portion.

13. The patient transfer and lifting device of claim 12, wherein said attachment mechanism is selected from a group consisting of a snap lock, a hook and loop fastener, an auto seat belt buckle and an airplane seat belt buckle.

14. A method of transferring an individual from a first seated position to a second position with a patient transfer and lifting device secured to a user, said method comprising the steps of:
providing said patient transfer and lifting device, wherein the patient transfer and lifting device comprises a pad and a belt and further wherein said belt is threaded around an outer perimeter of said pad;
positioning said pad under a posterior of said individual;
adjusting a length of said belt;
securing said pad and said belt together around said individual and said user;
lifting said individual from said first seated position; and
transferring said individual to said second position.

15. The method of claim 14, wherein said belt has an adjustable length that ranges from approximately 72 inches to approximately 156 inches.

16. The method of claim 15, wherein said belt further comprises an attachment mechanism for selectively removing said belt from said user.

17. The method of claim 16 further comprising the step of removing said pad from said posterior of said individual after said transferring.

18. The method of claim 17, wherein said pad has a length ranging from approximately 12 inches to approximately 42 inches, and a width ranging from approximately 12 inches to approximately 36 inches.

19. The method of claim 16, wherein said attachment mechanism is selected from a group consisting of a snap lock, a hook and loop fastener, an auto seat belt buckle and an airplane seat belt buckle.

20. The method of claim 14 wherein said patient transfer and lifting device further comprises an anti-microbial coating.
